(19) United States
(12) Patent Application Publication
(10) Pub. No.: US 2026/0191736 A1
(43) Pub. Date: Jul. 9, 2026

(54) ADULT SEX TOY FOR WOMEN

(71) Applicant: Dongguan Mimao Electronic Technology Co., Ltd., Dongguan (CN)

(72) Inventors: Qinling WANG, Heyuan (CN); yinyuan Li, Dongguan (CN); Qinduo Wang, Heyuan (CN)

(21) Appl. No.: 19/557,140

(22) Filed: Mar. 5, 2026

Related U.S. Application Data
(63) Continuation-in-part of application No. 19/028,201, filed on Jan. 17, 2025.

(30) Foreign Application Priority Data
Feb. 5, 2024 (CN) 202420279109.2
Oct. 17, 2024 (CN) 202422520082.4
Sep. 17, 2025 (CN) 202522005910.5
Jan. 20, 2026 (CN) 202620077321.X

(51) Int. Cl. A61H 19/00; A61H 23/00; A61H 23/02

(52) U.S. Cl. CPC A61H 19/44; A61H 23/006; A61H 23/0254; A61H 2201/1463; A61H 2201/149; A61H 2201/163; A61H 2201/1652; A61H 2201/1676

(57) ABSTRACT

An adult sex toy for women is disclosed in this disclosure. The adult sex toy for women includes a housing, a driving actuator, a swing rod, a massaging portion and at least one fixing member. The massaging portion is configured to perform percussive massage action on a human body or to be inserted into a bodily orifice for massage. Two ends of the swing rod are connected to the driving actuator and the massaging portion respectively. The massaging portion is disposed separately from the housing, and the driving actuator is configured to drive the swing rod to reciprocally swing. The adult sex toy for women can be fixed via the fixing member to make two hands free, thereby making the adult sex toy for women convenient to use. Furthermore, the massaging portion is separated from the housing, which increases the massage swing amplitude to meet user requirements.

### CROSS-REFERENCE TO RELATED APPLICATIONS

The present application is a Continuation in part Application of U.S. patent application Ser. No. 19/028,201, filed on Jan. 17, 2025, which claims the priorities of Chinese Patent Application No. 202522005910.5, filed on Sep. 17, 2025 and Chinese Patent Application No. 202620077321.X, filed on Jan. 20, 2026, the entire contents of which are hereby incorporated by reference.

### TECHNICAL FIELD

The present disclosure relates to the field of massage devices, in particular to an adult sex toy for women.

### BACKGROUND

With the increasing emphasis on health, massage devices closely related to physical well-being have been rapidly developing. Massage devices are popular recreational products for relieving fatigue in daily life, helping to promote blood circulation, enhance metabolism, and offer various other benefits. As a result, they are widely appreciated by people.

Currently, massage devices come in a variety of forms, mainly divided into two categories. The first category includes large and bulky devices such as massage chairs and massage tubs. The second category includes small and portable devices such as cervical spine massagers and lumbar spine massagers. Among these, small and portable massage devices, due to their compact and lightweight nature, are not restricted by usage scenarios or locations. They are also structurally simpler, which leads to lower production costs and retail prices, making them accessible to people of various age groups. Currently, small and portable massage devices generally require single-handed or even two-handed holding, which does not make two hands free and is very inconvenient to use; at the same time, these small and portable massage devices have a relatively small percussion massage force, and the massaging portion has a small massage swing amplitude, which cannot meet usage needs. Therefore, it is necessary to improve the massage devices.

### SUMMARY

The purpose of the disclosure is to provide an adult sex toy for women which is convenient for use, and can also enhance the sensing strength and depth of the massage of the adult sex toy for women, thereby improving the massage effect of the adult sex toy for women.

In order to achieve the above object, a technical solution of the present disclosure provides an adult sex toy for women, including:
a housing, defining a cavity;
a driving actuator, disposed in the cavity of the housing;
a swing rod;
a massaging portion, configured to perform percussive massage on a human body or to be inserted into a bodily orifice for massage; and
at least one fixing member fixedly connected to an external component;
wherein two ends of the swing rod are connected to the driving actuator and the massaging portion respectively, with one end of the swing rod extending into the housing and connected to the driving actuator, and the other end of the swing rod extending out of the housing and connected to the massaging portion; the massaging portion is disposed separately from the housing; the driving actuator is configured to drive the swing rod to reciprocally swing relative to the housing around a first axis direction.

In one of the embodiments, the fixing member is configured for wearing, and the fixing member comprises a fixing strap, and the fixing strap is made of flexible material.

In one of the embodiments, the fixing member further comprises two connecting buckles, each end of the fixing strap is connected to one connecting buckle respectively; the housing comprises a first shell and a second shell, the first shell and the second shell are coupled to form the housing; a portion of the connecting buckle extends into the housing, and another portion extends out of the housing and is connected to the fixing strap; the connecting buckles are fixed between the first shell and the second shell.

In one of the embodiments, the driving actuator comprises a driving motor, a deceleration mechanism, and a transmission mechanism, the driving motor, the deceleration mechanism, and the transmission mechanism are disposed in the cavity of the housing; the deceleration mechanism is connected to the driving motor and driven by the driving motor to rotate; the transmission mechanism is connected between the deceleration mechanism and the swing rod to transmit the motion from the deceleration mechanism to the swing rod.

In one of the embodiments, the deceleration mechanism comprises a casing and a transmission deceleration component; the casing is fixed inside the cavity; the transmission deceleration component is disposed inside the casing; an input end of the transmission deceleration component is connected to an output shaft of the driving motor; an output end of the transmission deceleration component is connected to the transmission mechanism; the transmission deceleration component is configured for deceleration so that the rotational speed at the output end is less than that at the input end.

In one of the embodiments, the transmission deceleration component comprises a worm wheel and a worm; the worm wheel and the worm are disposed inside the casing; the worm is connected to the output shaft of the driving motor; the worm is meshed with the worm wheel; the transmission deceleration component further comprises an output gear; the worm wheel is connected to the deceleration mechanism; or
the transmission deceleration component comprises a first bevel gear and a second bevel gear meshed with the first bevel gear; the first bevel gear is connected to the output shaft of the driving motor; the second bevel gear is connected the deceleration mechanism; or
the transmission deceleration component comprises a first spur gear and a second spur gear meshed with the first spur gear; the first spur gear is connected to the output shaft of the driving motor; the second spur gear is connected the deceleration mechanism.

In one of the embodiments, the transmission mechanism comprises a first turntable, a guide rail, a slider, an eccentric post, and a hinge shaft; the first turntable is connected to the output end of the deceleration mechanism and driven to rotate by the deceleration mechanism; the guide rail is fixed inside the housing and extends in a direction perpendicular to the first axis direction; the slider is slidably disposed on the guide rail; the slider is provided with a guide groove extending in a direction parallel to the first axis direction; the eccentric post is provided at an edge of the first turntable; the eccentric post is inserted into the guide groove and drives the slider to move along the guide rail; the hinge shaft is fixed to the slider and extends in a direction parallel to the first axis direction; the hinge shaft is passed through a hinge hole in the swing rod; or
the transmission mechanism comprises a second turntable, a connecting member, and a second rotating shaft; the second turntable is connected to the output end of the deceleration mechanism and driven to rotate by the deceleration mechanism; the second turntable is provided with an inclined post; one end of the inclined post is fixed to the second turntable, and the other end is hinged to one end of the connecting member to drive the connecting member to form a circular trajectory, thereby driving the swing rod to swing around the first axis direction; the second rotating shaft is provided at the other end of the connecting member; the second rotating shaft is rotatably passed through an axle hole in the swing rod; or
the transmission mechanism comprises a third turntable and an eccentric shaft; the inner end of the swing rod is provided with a hinge groove; the third turntable is connected to the output end of the deceleration mechanism and driven to rotate by the deceleration mechanism; the eccentric shaft is fixed to the edge of the third turntable and inserted into the hinge groove for hinged connection.

In one of the embodiments, an outer surface of the housing is recessed inwards to form a recess, and a remote controller is detachably provided in the recess; the remote controller is configured for remotely controlling the driving actuator.

In one of the embodiments, the adult sex toy for women further comprises an angle plate and an angle adjustment assembly; the angle plate is provided at the bottom of the housing; one end of the angle plate is rotatably connected to the housing around a second axis direction; the angle adjustment assembly is connected between the angle plate and the housing to adjust an angle between the angle plate and the housing.

In one of the embodiments, the angle adjustment assembly comprises an adjustment rod, a transmission rod, and a swing arm; the adjustment rod and the transmission rod are rotatably and immovably disposed relative to the housing; the adjustment rod is connected to the transmission rod to drive the transmission rod to rotate; the transmission rod is connected between the adjustment rod and the swing arm to drive one end of the swing arm to move in a direction perpendicular to the second axis direction; one end of the swing arm is hinged to the transmission rod, and the other end is hinged to the angle plate; the transmission rod is provided with a spiral guide groove; one end of the swing arm is provided with an insertion shaft inserted into the guide groove.

In one of the embodiments, an end of the massaging portion is rotatably connected to the outer end of the swing rod via an adjustment mechanism to allow angle adjustment to adjust an angle between the massaging portion and the housing.

In one of the embodiments, a circuit connection portion is provided at a connection portion between the massaging portion and the swing rod, allowing a battery inside the housing to supply power to electrical components, including a vibration motor inside the massaging portion.

In one of the embodiments, the circuit connection portion comprises a first connection plate disposed on the swing rod and a second connection plate disposed on the massaging portion; the first connection plate has two insulated first electrodes, and the second connection plate has two insulated second electrodes; the two first electrodes and the two second electrodes are in electrical contact respectively; one of the first electrode and the second electrode is arc-shaped or annular.

In one of the embodiments, the swing rod comprises a first part and a second part; one end of the massaging portion is clamped between the first part and the second part and fixedly connected; the adjustment mechanism comprises a first fastener and a second fastener; the second fastener passes through the second part, the one end of the massaging portion, and the first part in sequence and is connected to the first fastener.

In one of the embodiments, the massaging portion comprises a connecting shell and a soft body; the soft body is connected to the connecting shell; the connecting shell is connected to the swing rod.

In one of the embodiments, the soft body further comprises a base portion and a connection portion; one end of the connection portion is substantially perpendicularly connected to one end of the base portion; the massaging head is connected to an end of the connection portion away from the base portion.

In one of the embodiments, the massaging portion comprises a connecting shell and a soft body; the soft body is connected to the connecting shell; the connecting shell is connected to the swing rod; the soft body has a massaging end, and the massaging end is an elongated bar.

In one of the embodiments, the soft body further comprises a base portion; one end of the massaging end is substantially perpendicularly connected to one end of the base portion; the massaging portion further comprises a first inner shell and a second inner shell; the first inner shell is connected to the connecting shell; the base portion of the soft body is connected to the first inner shell and coated on the first inner shell; the massaging end is coated on the second inner shell.

In one of the embodiments, at least one vibration motor is provided inside the massaging portion.

In order to achieve the above object, another technical solution of the present application provides an adult sex toy for women, including:
a main body;
a massaging portion, having a penis-shaped massaging head or an elongated bar-shaped massaging end;
a swing rod, two ends of the swing rod connected to the main body and the massaging portion respectively; and

a fixing member, connected to the main body and configured to be fixed to a human body or an object;
wherein one end of the swing rod is pivotally connected to the main body to allow reciprocal swinging motion, the other end of the swing rod is fixedly connected to the massaging portion, the swinging motion of the swing rod drives the massaging portion to swing relative to the main body.

By providing the fixing member, the adult sex toy for women can be fixedly connected to an external component via the fixing member, eliminating the need for handheld operation, effectively make both the two hands free, and making the product more convenient to use; moreover, the massaging portion is disposed at the outer end of the swing rod and is separated from the housing to increase the massage swing amplitude, meeting usage needs.

### BRIEF DESCRIPTION OF DRAWINGS

FIG. 1 is a schematic structural view of an adult sex toy for women according to a first embodiment of the present disclosure.

FIG. 2 is a schematic structural view of the adult sex toy for women of FIG. 1 viewed from another aspect.

FIG. 3 is a cross-sectional view of the adult sex toy for women of FIG. 1.

FIG. 4 is an assembled, schematic view of a driving actuator and a swing rod of the adult sex toy for women of FIG. 1.

FIG. 5 is an exploded, schematic view of the driving actuator and the swing rod of the adult sex toy for women of FIG. 1.

FIG. 6 is a schematic structural view of a driving actuator and a swing rod of an adult sex toy for women according to a second embodiment of the present disclosure.

FIG. 7 is an exploded, schematic view of the driving actuator and the swing rod of the adult sex toy for women of FIG. 6.

FIG. 8 is a schematic structural view of a driving actuator and a swing rod of an adult sex toy for women according to a third embodiment of the present disclosure.

FIG. 9 is an exploded, schematic view of the driving actuator and the swing rod of the adult sex toy for women of FIG. 8.

FIG. 10 is a schematic structural view of an adult sex toy for women according to a fourth embodiment of the present disclosure.

FIG. 11 is a schematic structural view of the adult sex toy for women of FIG. 10 viewed from another aspect.

FIG. 12 is a cross-sectional view of the adult sex toy for women of FIG. 10.

FIG. 13 is an assembled, schematic view of a driving actuator and a swing rod of the adult sex toy for women of FIG. 10.

FIG. 14 is an assembled, schematic view of the driving actuator and the swing rod of the adult sex toy for women of FIG. 10 view from another aspect.

FIG. 15 is an exploded, schematic view of the driving actuator and the swing rod of the adult sex toy for women of FIG. 10.

FIG. 16 is an assembled, schematic view of an angle adjustment assembly and an angle plate of the adult sex toy for women of FIG. 10.

FIG. 17 is an exploded, schematic view of the angle adjustment assembly of the adult sex toy for women of FIG. 10.

FIG. 18 is a schematic view showing the adult sex toy for women of FIG. 10 secured to the waist of a human.

### DESCRIPTION OF EMBODIMENTS

In the following, the technical scheme of the present disclosure will be further explained in detail in combination with specific embodiments, which do not constitute any limitation to the present disclosure.

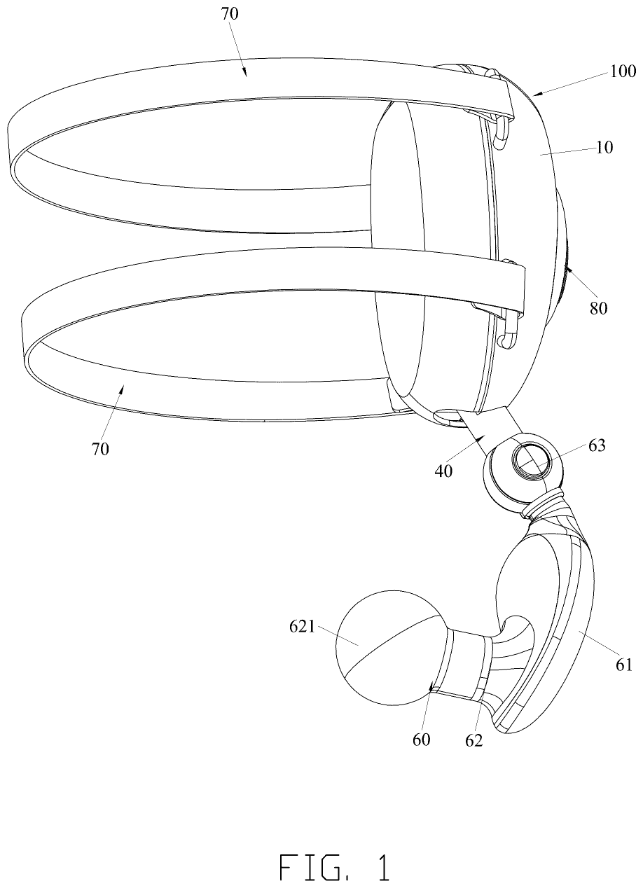

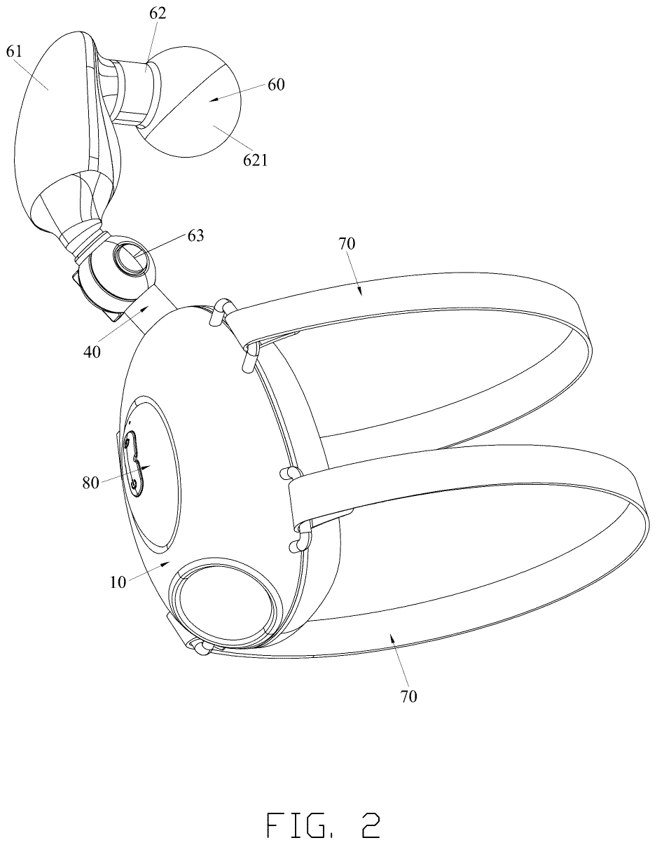

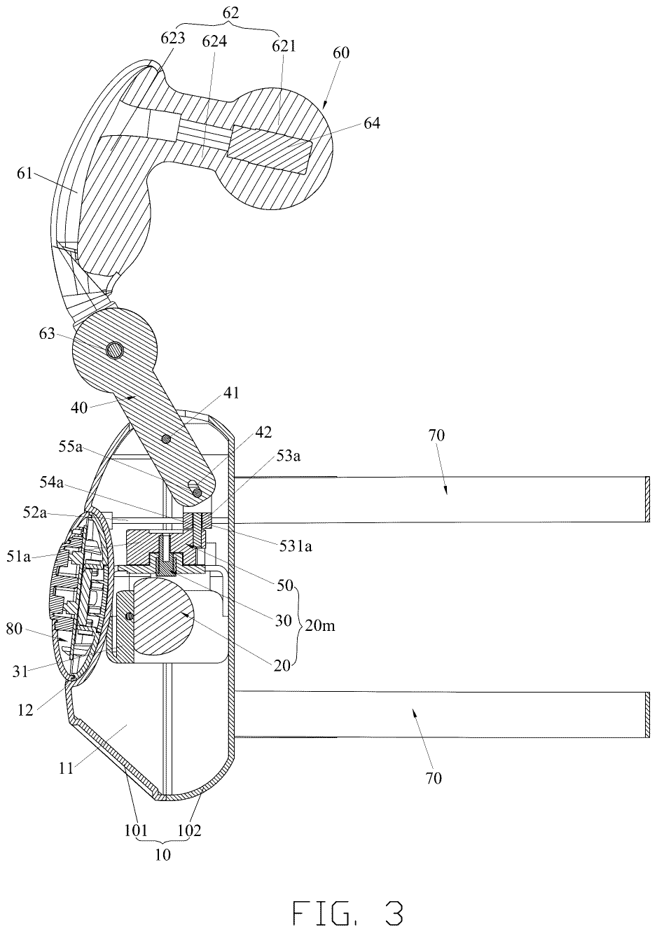

Referring to FIG. 1 to FIG. 3, an adult sex toy for women according to a first embodiment of the present disclosure is shown. In this embodiment, the adult sex toy for women includes a housing 10, a driving actuator 20m, a swing rod 40, a massaging portion 60, and a fixing member 70. The fixing member 70 is configured to connect to an external component (e.g., a human body, a chair, a table, etc.). The driving actuator 20m is provided in a cavity 11 of the housing 10. Two ends of the swing rod 40 are connected to the driving actuator 20m and the massaging portion 60 respectively, with one end of the swing rod 40 extending into the housing 10 and connected to the driving actuator 20m, and the other end extending out of the housing 10 and connected to the massaging portion 60. The driving actuator 20m is configured to drive the swing rod 40 to reciprocally swing around a first axis direction L1 (i.e., to reciprocally rotate by a certain angle around the first axis direction). The fixing member 70 is connected to the housing 10.

Specifically, the driving actuator 20m may include a driving motor 20, a deceleration mechanism 30, and a transmission mechanism 50.

The housing 10 is made of a hard material and can provide support for the driving actuator 20m etc. It may be made of plastic or other materials, not limited thereto. The housing 10 defines the cavity 11 therein. Moreover, an outer surface of the housing 10 is recessed inwards to form a recess 12. A remote controller 80 is disposed in the recess 12. The remote controller 80 remotely controls the driving motor 20, for example, to control the driving motor 20 to start or stop, or control a speed of the driving motor 20, thereby operating of the adult sex toy for women. Specifically, in this embodiment, the remote controller 80 is detachably provided in the recess 12. More specifically, a magnet may be provided on one of the recess 12 of the housing 10 and the remote controller 80, and the other is at least partially made of a material such as iron that can be attracted by the magnet, so that the remote controller 80 can be adsorbed to the recess 12 by magnetic force. This facilitates removal of the remote controller 80 from the recess 12 and also facilitates installing the remote controller 80 in the recess 12 to avoid loss and other issues, making it very convenient to use.

Specifically, the housing 10 includes a first shell 101 and a second shell 102. The first shell 101 and the second shell 102 are coupled together to form the housing 10. Specifically, in this embodiment, the housing 10 is generally ellipsoidal, and the first shell 101 and the second shell 102 are generally semi-ellipsoidal. Certainly, the housing 10 may also be cuboid, irregularly shaped, or other shapes, which does not substantially affect the function of the adult sex toy for women.

In this embodiment, the driving motor 20 is disposed inside the housing 10. Specifically, the driving motor 20 is located in the cavity 11.

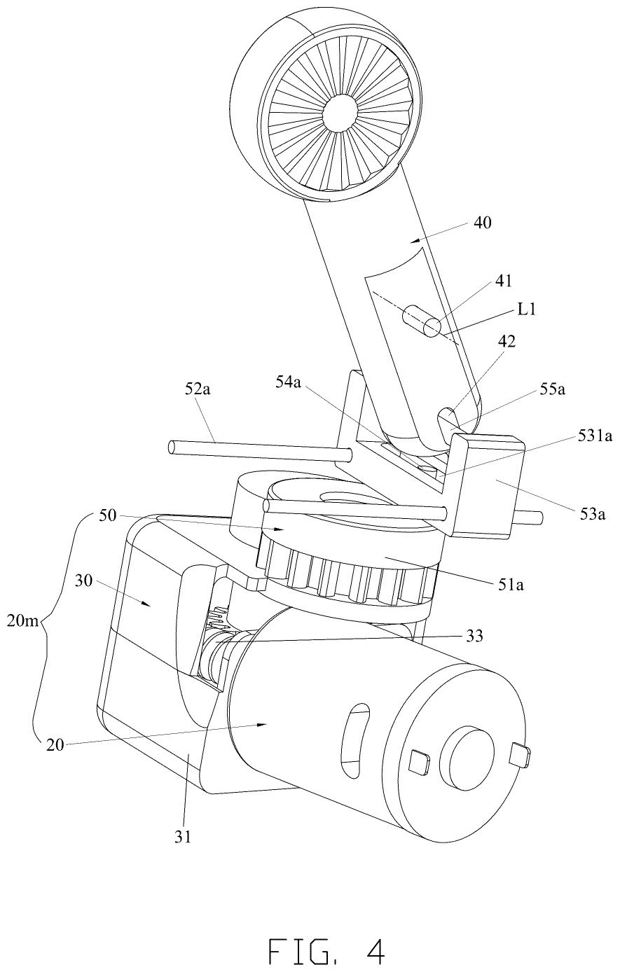

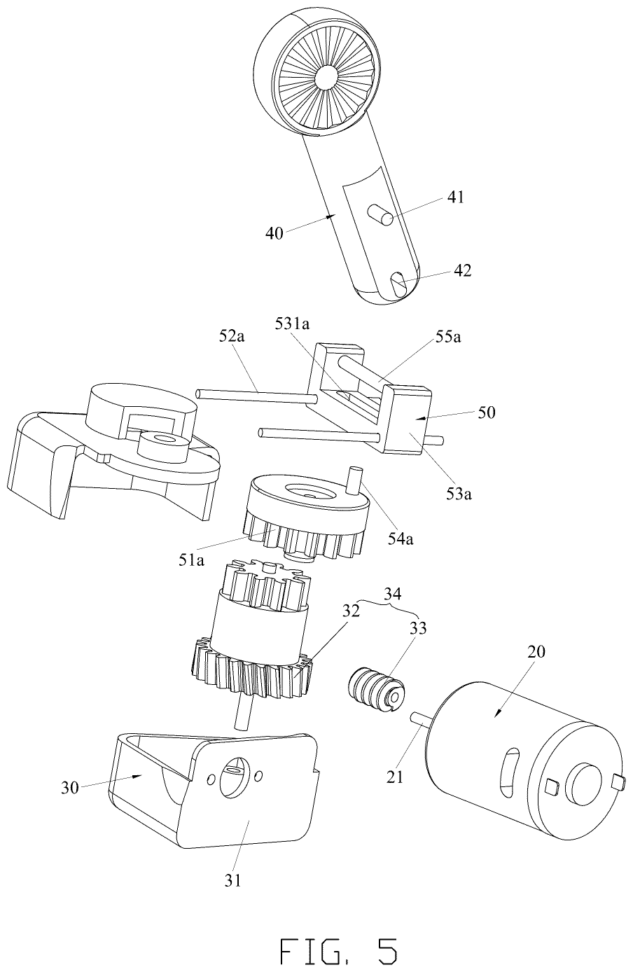

Referring also to FIG. 4 and FIG. 5, the deceleration mechanism 30 is disposed inside the housing 10. The deceleration mechanism 30 is driven by the driving motor 20. The main purpose of the deceleration mechanism 30 is to increase a driving torque. In this embodiment, the deceleration mechanism 30 is located in the cavity 11. Specifically, the deceleration mechanism 30 includes a casing 31 and a transmission deceleration component 34. The casing 31 is disposed inside the housing 10 and fixed in the cavity 11. The driving motor 20 is fixed on the casing 31. The transmission deceleration component 34 is provided inside the casing 31. An input end of the transmission deceleration component 34 is connected to an output shaft 21 of the driving motor 20. An output end of the transmission deceleration component 34 is connected to the transmission mechanism 50. The transmission deceleration component 34 is configured for deceleration so that the rotational speed at the output end of the transmission deceleration component 34 is less than that at the input end of the transmission deceleration component 34. More specifically, the transmission deceleration component 34 includes a worm wheel 32 and a worm 33. The worm wheel 32 is rotatably disposed inside the casing 31. The worm 33 is located inside the casing 31. The worm 33 is fixedly connected to the output shaft 21 of the driving motor 20, and the worm 33 is meshed with the worm wheel 32. It can be understood that the worm wheel 32 and worm 33 of the transmission deceleration component 34 may be replaced by other deceleration components, such as meshing gears, which are not limited here. For example, the transmission deceleration component 34 may include a first bevel gear and a second bevel gear meshed with the first bevel gear, and the first bevel gear is connected to the output shaft 21 of the driving motor 20. In embodiments where the transmission deceleration component 34 includes the worm wheel 32 and worm 33, and where the transmission deceleration component 34 includes the first and second bevel gears, the output shaft 21 of the driving motor 20 is perpendicular to the output axis of the transmission deceleration component 34. In another embodiment, the transmission deceleration component 34 may include a first spur gear and a second spur gear meshed with the first spur gear, and the first spur gear is connected to the output shaft 21 of the driving motor 20. In this case, the output shaft 21 of the driving motor 20 is parallel to the output axis of the transmission deceleration component 34.

The swing rod 40 is swingably connected to the housing 10. An inner end of the swing rod 40 extends into the housing 10, and an outer end of the swing rod 40 extends out of the housing 10. In this embodiment, the swing rod 40 is rotatably connected to the housing 10 via a first rotating shaft 41 extending along the first axis direction L1. The first rotating shaft 41 is located inside the housing 10. Moreover, the inner end of the swing rod 40 (i.e., the end inside the housing 10) is provided with a hinge hole 42, which is an elongated hole. The first rotating shaft 41 is located at a middle position of the swing rod 40. The first rotating shaft 41 is inserted at the middle position of the swing rod 40.

The transmission mechanism 50 is disposed inside the housing 10. The transmission mechanism 50 is connected between the deceleration mechanism 30 and the inner end of the swing rod 40. Specifically, the transmission mechanism 50 includes a first turntable 51a, a guide rail 52a, a slider 53a, an eccentric post 54a, and a hinge shaft 55a. The first turntable 51a is connected to an output end of the deceleration mechanism 30 and driven to rotate by the deceleration mechanism 30. The guide rail 52a is fixed inside the housing 10 and extends in a direction perpendicular to the first axis direction L1. The slider 53a is slidably disposed on the guide rail 52a. The slider 53a is provided with a guide groove 531a extending in a direction parallel to the first axis direction L1. The eccentric post 54a is provided at an edge of the first turntable 51a and extends along a direction perpendicular to the first axis direction L1 and the guide groove 531a. The eccentric post 54a is inserted into the guide groove 531a and drives the slider 53a to move along the guide rail 52a. The hinge shaft 55a is fixed to the slider 53a and extends in a direction parallel to the first axis direction L1. The hinge shaft 55a is passed through the hinge hole 42. In this embodiment, two guide rails 52a are provided and the two guide rails are spaced-apart and parallel to each other. The two guide rails 52a are guiding post. The two guide rails 52a pass through two ends of the slider 53a respectively.

The massaging portion 60 is disposed at the outer end of the swing rod 40 and is separated from the housing 10. The massaging portion 60 reciprocally swings together with the swing rod 40 around the first axis direction L1. In this embodiment, the massaging portion 60 includes a connecting shell 61 and a soft body 62. The connecting shell 61 is connected to the outer end of the swing rod 40 (i.e., the end of the swing rod 40 outside the housing 10). The soft body 62 is connected to the connecting shell 61. The soft body 62 has a massaging head 621, and the massaging head 621 may be ball-shaped. An end of the connecting shell 61 is rotatably connected to the outer end of the swing rod 40 via an adjustment mechanism 63 to allow adjusting an angle between the massaging portion 60 and swing rod 40. A vibration motor 64 is provided inside the massaging head 621. The soft body 62 may be made of soft material such as foam, silicone, rubber, TPE, etc., but not limited thereto. For example, the adjustment mechanism 63 may be an adjustment bolt. When the adjustment bolt is loosened, the massaging portion 60 can rotate around an axis of the adjustment bolt. After adjusting to a suitable angle, the massaging portion 60 can be locked to the swing rod 40 via the adjustment bolt.

Specifically, the soft body 62 may further include a base portion 623 and a connection portion 624. One end of the connection portion 624 is substantially perpendicularly connected to one end of the base portion 623, and the massaging head 621 is provided at an end of the connection portion 624 away from the base portion 623, thereby forming generally L-shaped soft body 62. In this embodiment, the massaging head 621, the base portion 623, and the connection portion 624 are all made of soft material and may be integrally formed. It can be understood that in other embodiments, the base portion 623 and connection portion 624 may also be made of hard material, with only the massaging head 621 made of soft material.

The fixing member 70 is disposed on the housing 10. In this embodiment, the fixing member 70 is made of a flexible material with adjustable length or a hard material with adjustable angle. In this embodiment, a number of the fixing member 70 is two. The number of the fixing member 70 may be one, three or more. The fixing member 70 may fix the massage device on the human body or on a subject such as a table to keep both two hands free, making massage convenient without the need to hold it for a long time. When fixing on the body, the fixing member 70 may be made of flexible material. The flexible material allows for adjustable length and may be cloth, leather, rubber, chain, etc. When fixing on a table, the fixing member 70 may be a soft binding member or other hard material bracket, etc.

The working principle of this embodiment is described in detail as follows:

During use, the adult sex toy for women is fixedly installed to outer component via the fixing member 70, with the massaging portion 60 facing the human body part to be massaged. For example, the fixing member 70 may be secured around the waist of a human. Then, the driving motor 20 is controlled via the remote controller 80, so that an external power source or an internal power source (not shown) supplies power to the driving motor 20. After the driving motor 20 is started, the driving motor 20 drives the deceleration mechanism 30 to rotate. Then, the deceleration mechanism 30 drives the swing rod 40 to reciprocally swing via the transmission mechanism 50. Subsequently, the swing rod 40 drives the massaging portion 60 to reciprocally swing, performing a percussion massage action on the human body part such as vagina, clit or anus of a woman. For example, the massaging head 621 of the massaging portion 60 may be inserted into a bodily orifice such as a vagina to perform an in-and-out motion.

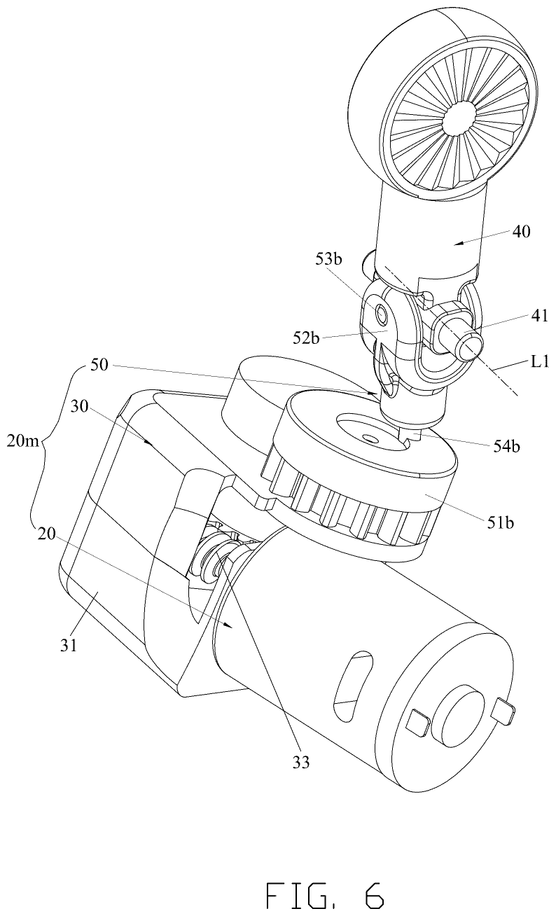

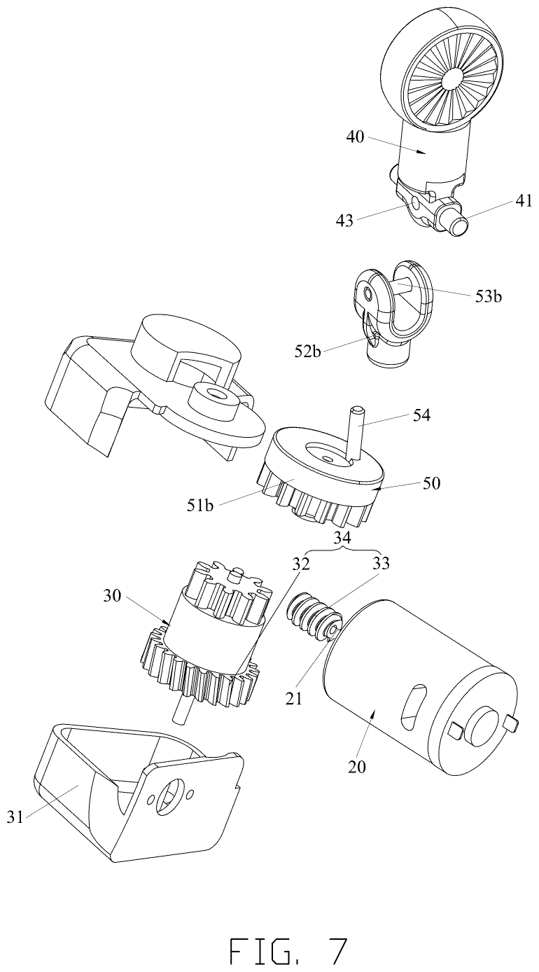

Referring to FIG. 6 to FIG. 7, a driving actuator and a swing rod of an adult sex toy for women according to a second embodiment of the present disclosure are shown. The specific structure of this embodiment is basically the same as that of the aforementioned first embodiment, with the main difference lying in the specific structure of the driving actuator 20m.

In this embodiment, the inner end of the swing rod 40 is provided with an axle hole 43. The first rotating shaft 41 integrally extends outward from both sides of the inner end of the swing rod 40. An axial direction of the axle hole 43 is perpendicular to the axial of the first rotating shaft 41.

The transmission mechanism 50 includes a second turntable 51b, a connecting member 52b, and a second rotating shaft 53b. The second turntable 51b is connected to an output end of the deceleration mechanism 30 and driven to rotate by the deceleration mechanism 30. One end of the connecting member 52b is hinged to the second turntable 51b via an inclined post 54b. The second rotating shaft 53b is provided at the other end of the connecting member 52b. The second rotating shaft 53b is passed through the axle hole 43.

The working principle of this embodiment is basically the same as that of the aforementioned first embodiment, and will not be described in detail here.

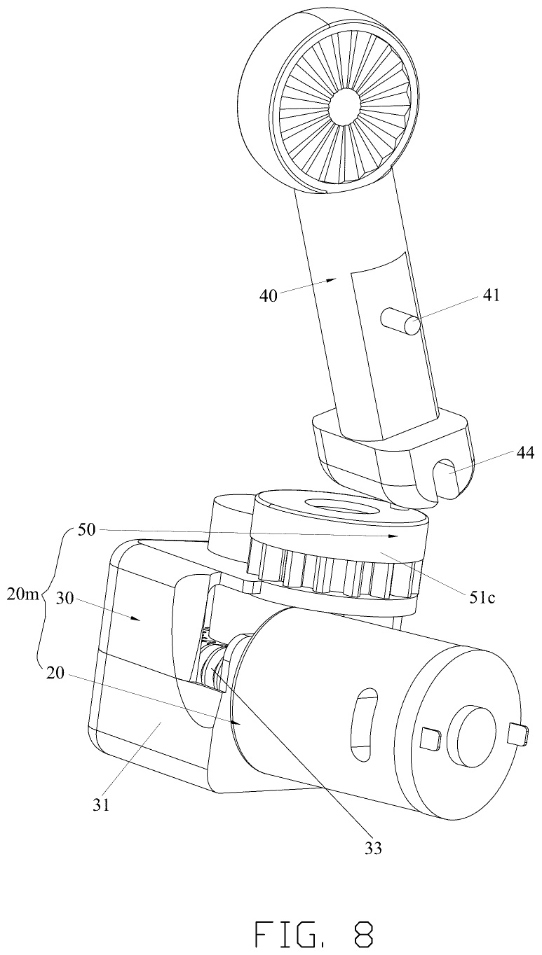

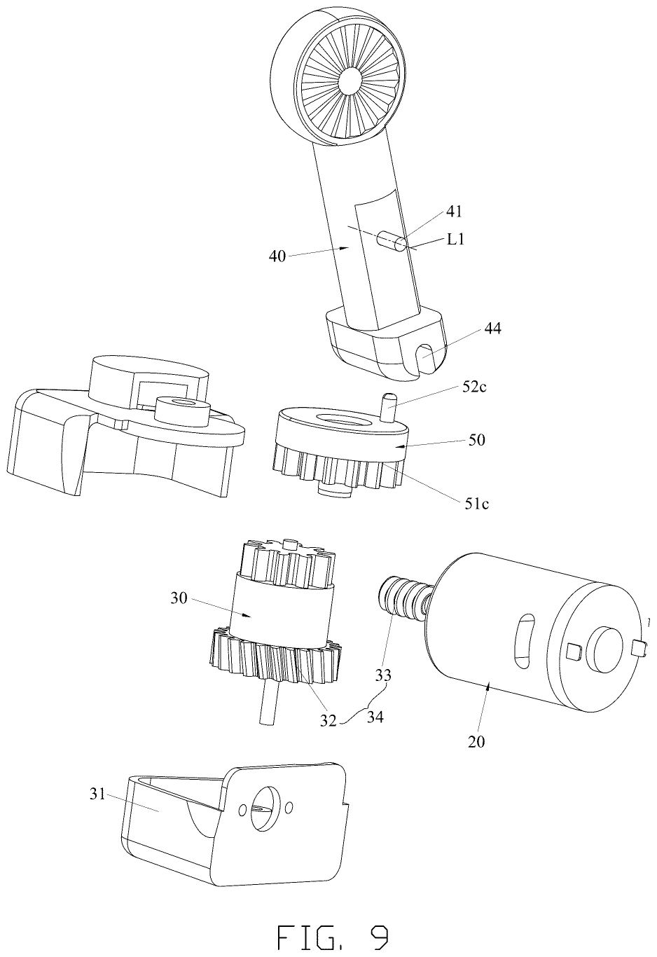

Referring to FIG. 8 to FIG. 9, a driving actuator and a swing rod of an adult sex toy for women of a third embodiment of the present disclosure. The specific structure of this embodiment is basically the same as that of the aforementioned first embodiment, with the main difference lying in the specific structure of the driving actuator 20m.

In this embodiment, the inner end of the swing rod 40 is provided with a hinge groove 44. The first rotating shaft 41 is located at a middle position of the swing rod 40.

The transmission mechanism 50 includes a third turntable 51c and an eccentric shaft 52c. The third turntable 51c is connected to an output end of the deceleration mechanism 30 and driven to rotate by the deceleration mechanism 30. The eccentric shaft 52c is fixed to an edge of the third turntable 51c. The eccentric shaft 52c is inserted into the hinge groove 44, and is rotatably and movably disposed in the hinge groove 44.

The working principle of this embodiment is basically the same as that of the aforementioned first embodiment, and will not be described in detail here.

The key design aspect of the adult sex toy for women of the present disclosure is: By providing the fixing member, the adult sex toy for women can be fixedly connected to external component via the fixing member, eliminating the need for handheld operation, effectively make both the two hands free, and making the product more convenient to use; by providing the deceleration mechanism, the driving torque can be increased, thereby enhancing the massage force; moreover, the massaging portion is disposed at the outer end of the swing rod and is separated from the housing to increase the massage swing amplitude, meeting usage needs.

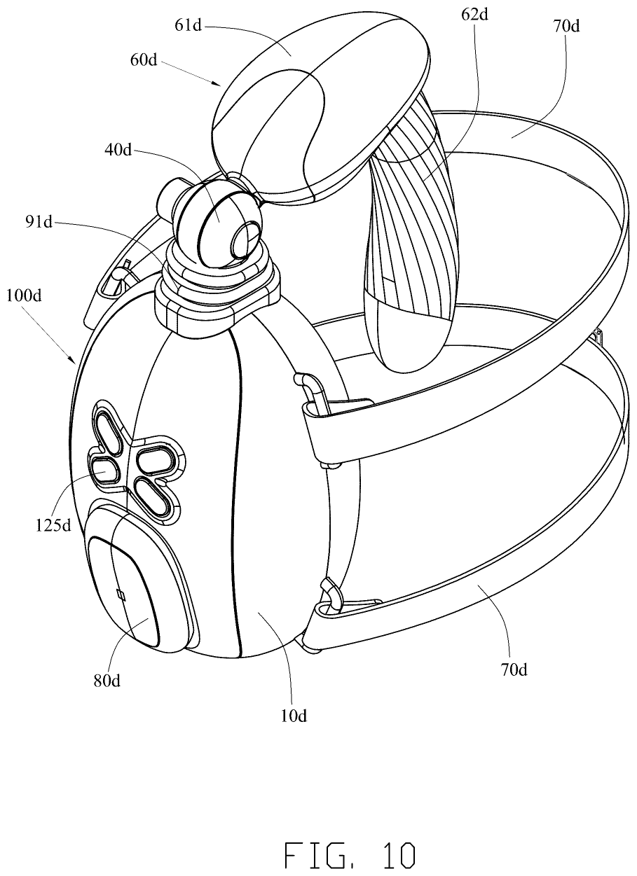

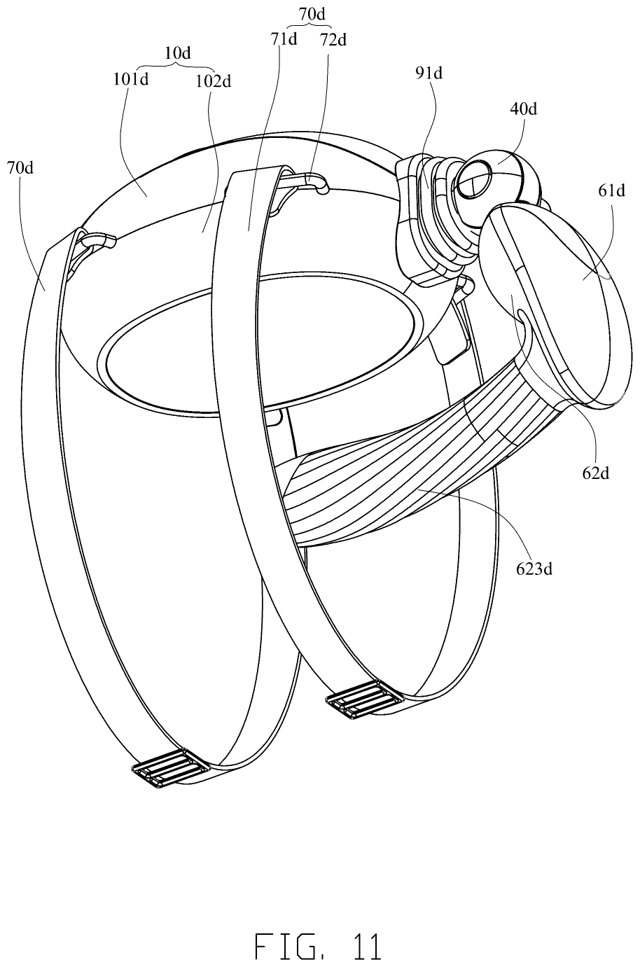

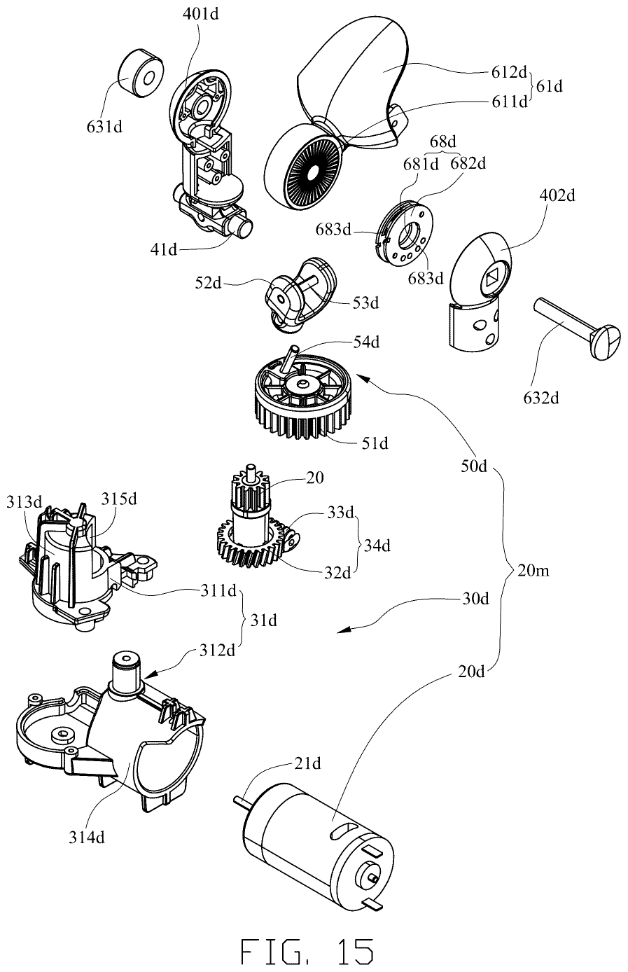

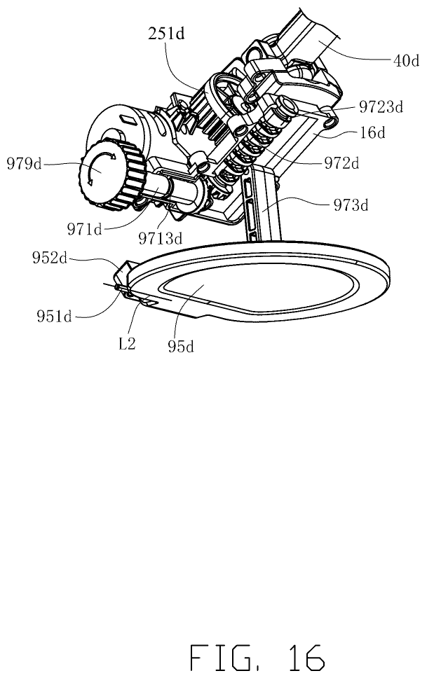

Referring to FIG. 10 to FIG. 17, an adult sex toy for women according to a fourth embodiment of the present disclosure is shown. The specific structure of this embodiment is basically the same as that of the aforementioned first embodiment, with the main differences lying in the specific structure of the massaging portion, the connection structure between the massaging portion and the swing rod, and an angle adjustment structure for adjusting an angle of the housing and massaging portion together relative to the human body or other external objects. The specific structure of the adult sex toy for women of the fourth embodiment is described in detail below.

In this embodiment, referring to FIG. 10 to FIG. 12, the adult sex toy for women of this embodiment includes a housing 10d, a driving actuator 20m, a swing rod 40d, a massaging portion 60d, and a fixing member 70d. The fixing member 70d is configured to be connected to the external component (e.g., the human body, a chair, a table, etc.). The driving actuator 20m is disposed in a cavity 11d of the housing 10d. Two ends of the swing rod 40d are connected to the driving actuator 20m and the massaging portion 60d respectively, with one end of the swing rod 40d extending into the housing 10d and connected to the driving actuator 20m, and the other end extending out of the housing 10d and connected to the massaging portion 60d. The driving actuator 20m is configured to drive the swing rod 40d to reciprocally swing around the first axis direction L1 (i.e., to reciprocally rotate by a certain angle around the first axis direction L1) to drive the massaging portion 60d to swing, achieving intermittent knocking action on the human body. The fixing member 70d is connected to the housing 10d.

In this embodiment, an outer surface of the housing 10d is recessed inwards to form a recess 12d. A remote controller 80d is detachably provided in the recess 12d. The specific arrangement of the recess 12d and remote controller 80d is similar to that of recess 12 and remote controller 80 of the first embodiment and will not be repeated here.

In this embodiment, the housing 10d includes a first shell 101d and a second shell 102d. The first shell 101d and the second shell 102d are coupled together to form the housing 10d. The first shell 101d is further provided with at least one control switch 125d. The adult sex toy for women may be controlled by the remote controller 80d or by the control switch 125d. In the embodiment illustrated in the drawings, the first shell 101d may be a double-layer structure, but it may also be a single layer.

In this embodiment, a protective sleeve 91d is sleeved on the swing rod 40d and is disposed between the housing 10 and the massaging portion 50. The protective sleeve 91d is a soft sleeve made of rubber or other materials and has deformation ability to adapt to the swing of the swing rod 40d. Specifically, the protective sleeve 91d is hollow and sleeve-shaped. With the protective sleeve 91d, dust prevention function and anti-pinch function are achieved.

In this embodiment, a battery 92d is provided in the cavity 11d of the housing 10d. The battery 92d is configured to supply power to the driving actuator 20m. In other embodiments, the driving actuator 20m may be powered by external powers, and the battery 92d may be omitted.

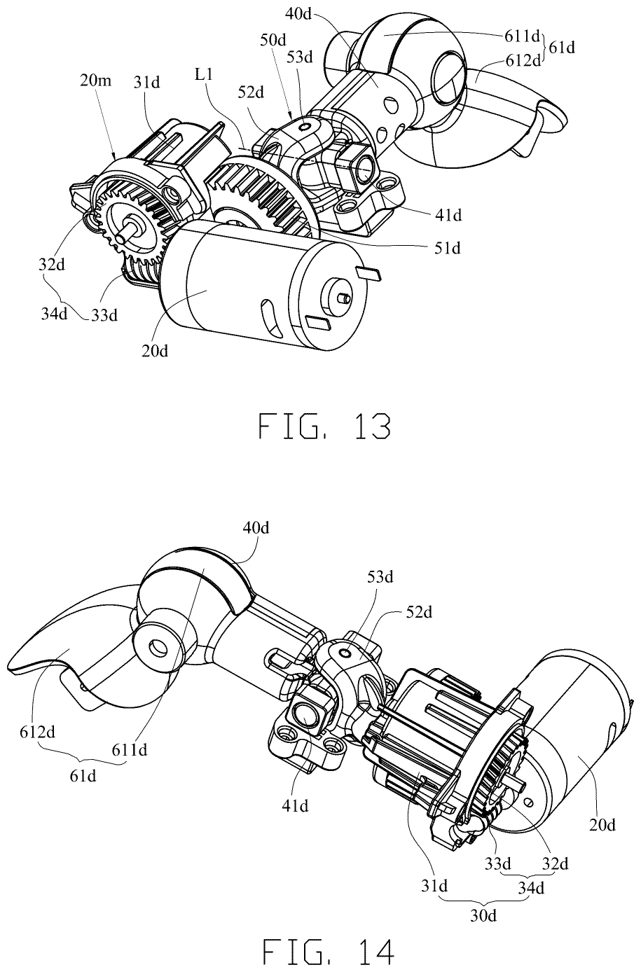

In this embodiment, referring to FIG. 13 to FIG. 15, the driving actuator 20m includes a driving motor 20d, a deceleration mechanism 30d, and a transmission mechanism 50d. The driving motor 20d, the deceleration mechanism 30d, and the transmission mechanism 50d are provided in the cavity 11d of the housing 10d. The deceleration mechanism 30d is driven by the driving motor 20d to rotate. The main purpose of the deceleration mechanism 30d is to increase the driving torque. The transmission mechanism 50d is connected between the deceleration mechanism 30d and the swing rod 40d. By providing the deceleration mechanism 30d, the driving torque can be increased, thereby enhancing the percussion massage force. Specifically, the deceleration mechanism 30d includes a casing 31d and a transmission deceleration component 34d. The transmission deceleration component 34d includes a worm wheel 32d and a worm 33d meshed with the worm wheel 32d. In this embodiment, the casing 31d includes a first casing 311d and a second casing 312d connected to the first casing 311d. The first casing 311d has a cylindrical first receiving portion 313d, and the second casing 312d has a cylindrical second receiving portion 314d. The transmission deceleration component 34d is accommodated in the first receiving portion 313d. Part of the driving motor 20d is accommodated in the second receiving portion 314d. One side of the first receiving portion 313d defines an open port 315d for allowing the transmission deceleration component 34d to connect with the transmission mechanism 50d outside the first casing 311d. Specifically, in this embodiment, an axis of the first receiving portion 313d and an axis the second receiving portion 314d are perpendicular to each other. The structures of the driving motor 20d and deceleration mechanism 30d in this embodiment are similar to those of the driving motor 20 and the deceleration mechanism 30 of the adult sex toy for women of the second embodiment and will not be repeated here.

In this embodiment, the transmission mechanism 50d includes a second turntable 51d, a connecting member 52d, and a second rotating shaft 53d. One end of the second turntable 51d is provided with an inclined post 54d rotatably connected to the connecting member 52d. The structure of the transmission mechanism 50d in this embodiment is basically the same as that of the transmission mechanism 50 in the second embodiment and will not be repeated here. During operation, the driving motor 20d runs to drive the worm 33d and worm wheel 32d to rotate, thereby driving the second turntable 51d to rotate. Since the inclined post 54d is eccentrically arranged, the rotation of the second turntable 51d drives one end of the connecting member 52d to swing along a circular trajectory, forming a circular orbit, thereby driving the swing rod 40d to swing around the first axis direction L1. During this process, the swing rod 40d rotates relative to the connecting member 52d around the second rotating shaft 53d by a certain angle. It can be understood that the d transmission mechanism 50d may be replaced by the transmission mechanism 50 in the first and third embodiments.

In this embodiment, the swing rod 40d is swingably connected to the housing 10d. The inner end of the swing rod 40d extends into the housing 10d, and the outer end of the swing rod 40d extends out of the housing 10d. The swing rod 40d is rotatably connected to the housing 10d via a first rotating shaft 41d extending in the first axis direction L1. The first rotating shaft 41d is located inside the housing 10d. Specifically, in this embodiment, the swing rod 40d includes a first part 401d and a second part 402d. One end of the massaging portion 60d is clamped between the first part 401d and the second part 402d and fixedly connected.

Specifically, one end of the massaging portion 60d may be rotatably connected to the outer end of the swing rod 40d via an adjustment mechanism 63d to adjust angle between the massaging portion 60d and the swing rod 40d. Specifically, in this embodiment, the adjustment mechanism 63d includes a first fastener 631d and a second fastener 632d. The second fastener 632d passes the second part 402d, one end of the massaging portion 60d, and the first part 401d in sequence and is connected to the first fastener 631d located. More specifically, the first fastener 631d may be a nut, and the second fastener 632d may be a bolt. By loosening the connection between the nut and bolt, the relative angle between the massaging portion 60d and the swing rod 40d may be adjusted. By fastening the connection between the nut and the bolt, the massaging portion 60d and the swing rod 40d are fixed. It can be understood that the nut and bolt may be replaced by a pin and a snap ring that can engage with the pin.

The massaging portion 60d is disposed at the outer end of the swing rod 40d and is separated from the housing 10d. The massaging portion 60d reciprocally swings together with the swing rod 40d around the first axis direction L1. In this embodiment, the massaging portion 60d includes a connecting shell 61d and a soft body 62d. The connecting shell 61d is connected to the outer end of the swing rod 40d. The soft body 62d is connected to the connecting shell 61d. The soft body 62d has a massaging end 621d. An end of the connecting shell 61d is rotatably connected to the outer end of the swing rod 40d via the adjustment mechanism 63d to allow adjusting angle between the massaging portion 60d and the swing rod 40d. At least one vibration motor 64d may be provided inside the massaging end 62d. The soft body 62d may be made of foam, silicone, rubber, TPE, etc., not limited thereto.

Specifically, the connecting shell 61d includes a connection end 611d and a support shell 612d connected to one side of the connection end 611d. The connection end 611d is clamped between the first part 401d and the second part 402d of the swing rod 40d. The support shell 612d is a hollow shell. The soft body 62d is connected to the support shell 612d.

Specifically, the soft body 62d may further include a base portion 623d. One end of the massaging end 621d is substantially perpendicularly connected to one end of the base portion 623d, thereby forming generally L-shaped soft body 62d. In this embodiment, the massaging end 621d and base portion 623d are made of soft material and may be integrally formed. It can be understood that in other embodiments, the base portion 623d may also be made of hard material, with only the massaging end 621d made of soft material. In this embodiment, the vibration motor 64d mentioned above is provided inside the base portion 623d and/or the massaging end 621d. Specifically, in this embodiment, the massaging end 621 is an elongated bar or shaped like a male penis. The massaging end 621d may perform a massage action on the human body part such as vagina, clit or anus of a woman. For example, the massaging end 621d may be inserted into a bodily orifice such as the vagina and reciprocally move in and out of the channel with the reciprocally swing of the swing rod 40d, producing good stimulation and massage effects. The massaging end 621 may perform a percussion massage action on human body part. It can be understood that the massaging head 621 of the first to third embodiments may also be inserted into a bodily orifice such as the vagina and reciprocally move in and out.

Specifically, the massaging portion 60d further includes a first inner shell 66d and a second inner shell 67d. The first inner shell 66d is connected to the support shell 612d of the connecting shell 61d. The base portion 623d of the soft body 62d is connected to the first inner shell 66d and coated on the first inner shell 66d. The massaging end 621d is coated on the second inner shell 67d. One vibration motor 64d is provided inside the second inner shell 67d. The first inner shell 66d and second inner shell 67d are hard shells and provide support for the soft body 62d.

In this embodiment, a circuit connection portion 68d may be provided at the connecting portion between the massaging portion 60 and the swing rod 40d, so that the battery 92d inside the housing 10d can supply power to electrical components such as the vibration motor 64d inside the massaging portion 60. Specifically, the circuit connection portion 68d includes a first connection plate 681d disposed on the swing rod 40d and a second connection plate 682d disposed on the connecting shell 61d of the massaging portion 60d. The first connection plate 681d has two insulated first electrodes 683d. The second connection plate 682d has two insulated second electrodes 684d. The two first electrodes 683d and the two second electrodes 684d are in electrical contact respectively, that is, one first electrode 683 is electrically contact to one second electrode 684d and the other first electrode 683 is electrically contact to the other second electrode 684d. In this embodiment, the first electrode 683d is arc-shaped or annular (the central angle of the arc or circle is determined according to the angle adjustment range of the adjustment mechanism 63d). When the adjustment mechanism 63d adjusts the angle of the massaging portion 60d relative to the swing rod 40d, the second electrode 684d always remains in electrical connection with the first electrode 683d. It can be understood that the second electrode 684d may be designed as arc-shaped or annular.

In this embodiment, the fixing member 70d is configured for wearing, and the adult sex toy for women may be fixed to human body or on an object such as a table to keep both two hands free, making massage convenient without the need to hold it for a long time. The fixing member 70d may include a fixing strap 71d. When fixing on the body, the fixing strap 71d may be made of flexible material. The flexible material allows for adjustable length and may be cloth, leather, rubber, chain, etc. When fixing on a table, the fixing strap 71d may be a soft binding member or other hard material bracket, etc. A number of the fixing strap 71d is two. Certainly, the number of fixing straps 71d may be set as needed and is not limited here. Specifically, in this embodiment, the fixing strap 71d is a binding strap. The fixing strap 71d may be an elastic rubber strap, rope, or other flexible strap. This embodiment does not impose excessive limitations on this. The fixing member 70d further includes two connecting buckle 72d connected to the fixing strap 71d. The connecting buckles 72d are fixedly connected to the housing 10d. Two ends of the fixing strap 71d are respectively connected to one connecting buckle 72d. Specifically, one fixing strap 71d is connected to the corresponding two connecting buckles 72d. Specifically, a portion of the connecting buckle 72d extends into the housing 10d, and another portion extends out of the housing 10d and is connected to the fixing strap 71d. When the first shell 101d and the second shell 102d are coupled, the connecting buckle 72d is fixed to the housing 10d. It can be understood that, the connecting buckles 72d may be omitted, and two ends of the fixing strap 71d may be connected to the housing 10d directly.

When using the adult sex toy for women, the housing 10d can be worn on the body via the fixing member 70d, and the massaging portion 60d is indirectly fixed on the body, making the massage device not limited by usage scenarios and locations, enhancing the sensing strength and depth of the massage, and improving the massage effect of the adult sex toy for women.

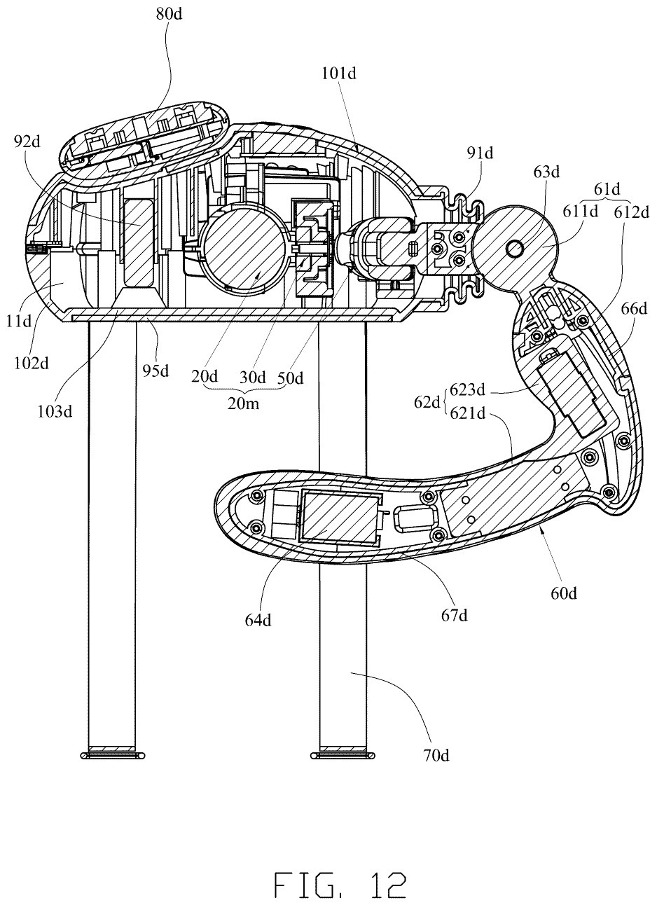

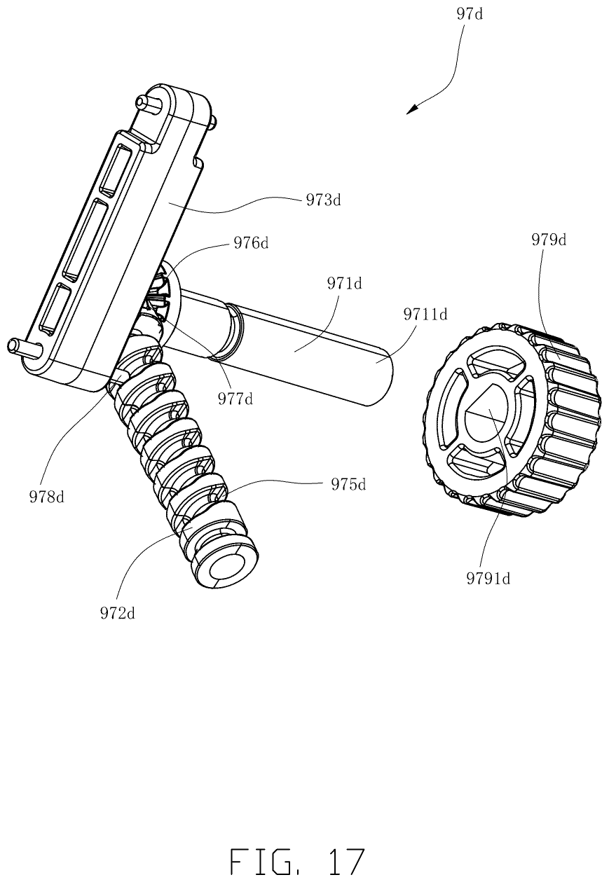

In this embodiment, referring to FIG. 16 and FIG. 17, the housing 10d has a bottom plate 103d at its bottom (see FIG. 12). The adult sex toy for women further includes an angle plate 95d. The angle plate 95d is provided at the bottom of the housing 10d. One end of the angle plate 95d is rotatably connected to the housing 10d around a second axis direction L2 to adjust an angle between the angle plate 95d and the housing 10d. The angle between the angle plate 95d and the housing 10d mentioned here may be the angle between the angle plate 95d and the bottom plate 103d of the housing 10d, or of course, it may be an angle between the angle plate 95d and other parts of the housing 10d, as long as it expresses the change in relative angle between the angle plate 95d and the housing 10d. The angle plate 95d is configured to be supported on human body (e.g., the human abdomen). By adjusting the angle of the angle plate 95d, the angle of the housing 10d relative to the human body can be adjusted, thereby changing the angle of the massaging portion 60d relative to the human body. Specifically, one end of the angle plate 95d is hinged to a mounting base 952d provided inside the second shell 102d of the housing 10d via a pivot shaft 951d.

In this embodiment, the adult sex toy for women further includes an angle adjustment assembly 97d. The angle adjustment assembly 97d is connected between the angle plate 95d and the housing 10d to drive the angle plate 95d to rotate relative to the housing 10d, thereby adjusting the angle between the angle plate 95d and the bottom plate 103d of the housing 10d.

Specifically, the angle adjustment assembly 97d includes an adjustment rod 971d, a transmission rod 972d, and a swing arm 973d. The adjustment rod 971d and transmission rod 972d are rotatably and immovably disposed relative to the housing 10d. The transmission rod 972d is connected between the adjustment rod 971d and the swing arm 973d to drive one end of the swing arm 973d to move in a direction perpendicular to the second axis direction L2. One end of the swing arm 973d is hinged to the transmission rod 972d, and the other end of the swing arm 973d is hinged to the angle plate 95d. The rotation of the adjustment rod 971d drives the swing arm 973d to swing (i.e., rotate in a certain angle), thereby driving the housing 10d to rotate relative to the angle plate 95d, thus adjusting the relative angle between the housing 10d and the angle plate 95d. Specifically, the transmission rod 972d defines a spiral guide groove 975d. One end of the swing arm 973d is provided with an insertion shaft 978d inserted into the guide groove 975d. More specifically, one end of the adjustment rod 971d is provided with a first gear 976d. One end of the transmission rod 972d is provided with a second gear 977d meshed with the first gear 976d. The adjustment rod 971d is connected to the transmission rod 972d via the first gear 976d and second gear 977d to drive the transmission rod 972d to rotate. A base plate 16d is provided inside the housing 10d. The adjustment rod 971d defines a first locking groove 9713d, and the transmission rod 972 defines a second locking groove 9723d. The first locking groove 9713d and second locking groove 9723d are engaged with side plates of the base plate 16d, thereby preventing the adjustment rod 971d and transmission rod 972d from moving linearly along their axial directions while allowing only rotation. Rotation of the adjustment rod 971d drives the transmission rod 972d to rotate. The insertion shaft 978d moves up and down within the guide groove 975d, thereby driving one end of the swing arm 973d to move. Specifically, in this embodiment, the adjustment rod 971d is perpendicular to the transmission rod 972d. It can be understood that the angle adjustment assembly 97d may be other structures. For example, the angle adjustment assembly 97d may be a telescopic structure (e.g., a piston cylinder such as an oil cylinder) with two ends hinged to the housing 10d and the angle plate 95d respectively. By adjusting the length of the telescopic structure, the angle between the angle plate 95d and the housing 10d is adjusted.

Specifically, the angle adjustment assembly 97d further includes an adjustment knob 979d. The adjustment knob 979d is connected to one end of the adjustment rod 971d. The adjustment rod 971d and transmission rod 972d are disposed inside the housing 10d. One end of the swing arm 973d extends into the housing 10d, and the other end extends out of the housing 10d through a slot in the second shell 102s. The adjustment knob 979d is located outside the housing 10d for convenient operation. Specifically, the adjustment knob 979d defines an engaging hole 9791d having a flat surface to cooperate with an engaging pin 9711d having a flat surface of the adjustment rod 971d, achieving non-rotatable connection between the adjustment knob 979d and the adjustment rod 971d. It can be understood that the engaging hole 9791d and the engaging pin 9711d may also be rectangular holes, elliptical holes, or other shapes.

It can be understood that in the aforementioned first to third embodiments, the housing 10 and components located within it, such as the driving actuator 20m, collectively constitute a main body 100. In the fourth embodiment, the housing 10d and components located within it, such as the driving actuator 20m, collectively constitute the main body 100d. The main body 100d and the massaging portion 60 (60d) are located at opposite ends of the swing rod 40 (40d). The main body 100 (100d) can be fixed to the human body or an object such as a table. One end of the swing rod 40 (40d) is pivotally connected to the main body 100d to allow reciprocal swinging motion, while the other end of the swing rod 40 (40d) is fixedly connected to the massaging portion 60 (60d). The swinging motion of the swing rod 40 (40d) drives the massaging portion 60 (60d) to swing relative to the main body 100 (100d).

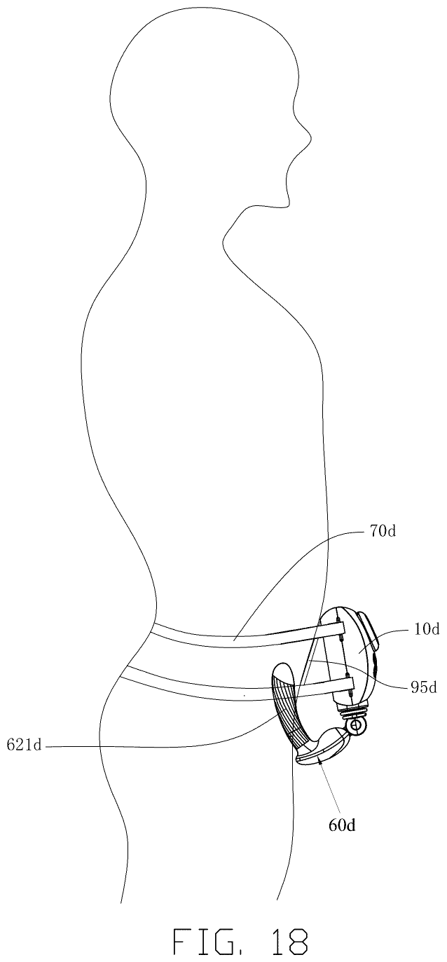

For example, as shown in FIG. 18, the fixing member 70d may be secured around the waist of a human, while the angle plate 95d resists against the lower abdomen of the human. Thereby, the massaging end 621d targets the female genital region, including the vulva, vagina, and anus.

The above merely describes specific embodiments of the present disclosure, which is not intended to limit the scope of protection of the present disclosure in any form. Any modifications, equivalent variations or substitutions, and improvements made under the spirit and principle of the present disclosure by those skilled in the art according to the disclosed technical scope should be included within the protection scope of the present disclosure.

What is claimed is:

1. An adult sex toy for women, comprising:
a housing, defining a cavity;
a driving actuator, disposed in the cavity of the housing;
a swing rod;
a massaging portion, configured to perform percussive massage on a human body or to be inserted into a bodily orifice for massage; and
at least one fixing member fixedly connected to an external component;
wherein two ends of the swing rod are connected to the driving actuator and the massaging portion respectively, with one end of the swing rod extending into the housing and connected to the driving actuator, and the other end of the swing rod extending out of the housing and connected to the massaging portion; the massaging portion is disposed separately from the housing; the driving actuator is configured to drive the swing rod to reciprocally swing relative to the housing around a first axis direction.

2. The adult sex toy for women of claim 1, wherein the fixing member is configured for wearing, and the fixing member comprises a fixing strap, and the fixing strap is made of flexible material.

3. The adult sex toy for women of claim 2, wherein the fixing member further comprises two connecting buckles, each end of the fixing strap is connected to one connecting buckle respectively; the housing comprises a first shell and a second shell, the first shell and the second shell are coupled to form the housing; a portion of the connecting buckle extends into the housing, and another portion extends out of the housing and is connected to the fixing strap; the connecting buckles are fixed between the first shell and the second shell.

4. The adult sex toy for women of claim 1, wherein the driving actuator comprises a driving motor, a deceleration mechanism, and a transmission mechanism, the driving motor, the deceleration mechanism, and the transmission mechanism are disposed in the cavity of the housing; the deceleration mechanism is connected to the driving motor and driven by the driving motor to rotate; the transmission mechanism is connected between the deceleration mechanism and the swing rod to transmit the motion from the deceleration mechanism to the swing rod.

5. The adult sex toy for women of claim 4, wherein the deceleration mechanism comprises a casing and a transmission deceleration component; the casing is fixed inside the cavity; the transmission deceleration component is disposed inside the casing; an input end of the transmission deceleration component is connected to an output shaft of the driving motor; an output end of the transmission deceleration component is connected to the transmission mechanism; the transmission deceleration component is configured for deceleration so that the rotational speed at the output end is less than that at the input end.

6. The adult sex toy for women of claim 5, wherein
the transmission deceleration component comprises a worm wheel and a worm; the worm wheel and the worm are disposed inside the casing; the worm is connected to the output shaft of the driving motor; the worm is meshed with the worm wheel; the transmission deceleration component further comprises an output gear; the worm wheel is connected to the deceleration mechanism; or
the transmission deceleration component comprises a first bevel gear and a second bevel gear meshed with the first bevel gear; the first bevel gear is connected to the output shaft of the driving motor; the second bevel gear is connected the deceleration mechanism; or
the transmission deceleration component comprises a first spur gear and a second spur gear meshed with the first spur gear; the first spur gear is connected to the output shaft of the driving motor; the second spur gear is connected the deceleration mechanism.

7. The adult sex toy for women of claim 5, wherein
the transmission mechanism comprises a first turntable, a guide rail, a slider, an eccentric post, and a hinge shaft; the first turntable is connected to the output end of the deceleration mechanism and driven to rotate by the deceleration mechanism; the guide rail is fixed inside the housing and extends in a direction perpendicular to the first axis direction; the slider is slidably disposed on the guide rail; the slider is provided with a guide groove extending in a direction parallel to the first axis direction; the eccentric post is provided at an edge of the first turntable; the eccentric post is inserted into the guide groove and drives the slider to move along the guide rail; the hinge shaft is fixed to the slider and extends in a direction parallel to the first axis direction; the hinge shaft is passed through a hinge hole in the swing rod; or
the transmission mechanism comprises a second turntable, a connecting member, and a second rotating shaft; the second turntable is connected to the output end of the deceleration mechanism and driven to rotate by the deceleration mechanism; the second turntable is provided with an inclined post; one end of the inclined post is fixed to the second turntable, and the other end is hinged to one end of the connecting member to drive the connecting member to form a circular trajectory, thereby driving the swing rod to swing around the first axis direction; the second rotating shaft is provided at the other end of the connecting member; the second rotating shaft is rotatably passed through an axle hole in the swing rod; or
the transmission mechanism comprises a third turntable and an eccentric shaft; the inner end of the swing rod is provided with a hinge groove; the third turntable is connected to the output end of the deceleration mechanism and driven to rotate by the deceleration mechanism; the eccentric shaft is fixed to the edge of the third turntable and inserted into the hinge groove for hinged connection.

8. The adult sex toy for women of claim 1, wherein an outer surface of the housing is recessed inwards to form a recess, and a remote controller is detachably provided in the recess; the remote controller is configured for remotely controlling the driving actuator.

9. The adult sex toy for women of claim 1, wherein the adult sex toy for women further comprises an angle plate and an angle adjustment assembly; the angle plate is provided at the bottom of the housing; one end of the angle plate is rotatably connected to the housing around a second axis direction; the angle adjustment assembly is connected between the angle plate and the housing to adjust an angle between the angle plate and the housing.

10. The adult sex toy for women of claim 9, wherein the angle adjustment assembly comprises an adjustment rod, a transmission rod, and a swing arm; the adjustment rod and the transmission rod are rotatably and immovably disposed relative to the housing; the adjustment rod is connected to the transmission rod to drive the transmission rod to rotate; the transmission rod is connected between the adjustment rod and the swing arm to drive one end of the swing arm to move in a direction perpendicular to the second axis direction; one end of the swing arm is hinged to the transmission rod, and the other end is hinged to the angle plate; the transmission rod is provided with a spiral guide groove; one end of the swing arm is provided with an insertion shaft inserted into the guide groove.

11. The adult sex toy for women of claim 1, wherein, an end of the massaging portion is rotatably connected to the outer end of the swing rod via an adjustment mechanism to allow angle adjustment to adjust an angle between the massaging portion and the housing.

12. The adult sex toy for women of claim 11, wherein a circuit connection portion is provided at a connection portion between the massaging portion and the swing rod, allowing a battery inside the housing to supply power to electrical components, including a vibration motor inside the massaging portion.

13. The adult sex toy for women of claim 12, wherein the circuit connection portion comprises a first connection plate disposed on the swing rod and a second connection plate disposed on the massaging portion; the first connection plate has two insulated first electrodes, and the second connection plate has two insulated second electrodes; the two first electrodes and the two second electrodes are in electrical contact respectively; one of the first electrode and the second electrode is arc-shaped or annular.

14. The adult sex toy for women of claim 11, wherein the swing rod comprises a first part and a second part; one end of the massaging portion is clamped between the first part and the second part and fixedly connected; the adjustment mechanism comprises a first fastener and a second fastener; the second fastener passes through the second part, the one end of the massaging portion, and the first part in sequence and is connected to the first fastener.

15. The adult sex toy for women of claim 1, wherein the massaging portion comprises a connecting shell and a soft body; the soft body is connected to the connecting shell; the connecting shell is connected to the swing rod.

16. The adult sex toy for women of claim 15, wherein the soft body further comprises a base portion and a connection portion; one end of the connection portion is substantially perpendicularly connected to one end of the base portion; the massaging head is connected to an end of the connection portion away from the base portion.

17. The adult sex toy for women of claim 1, wherein the massaging portion comprises a connecting shell and a soft body; the soft body is connected to the connecting shell; the connecting shell is connected to the swing rod; the soft body has a massaging end, and the massaging end is an elongated bar.

18. The adult sex toy for women of claim 17, wherein the soft body further comprises a base portion; one end of the massaging end is substantially perpendicularly connected to one end of the base portion; the massaging portion further comprises a first inner shell and a second inner shell; the first inner shell is connected to the connecting shell; the base portion of the soft body is connected to the first inner shell and coated on the first inner shell; the massaging end is coated on the second inner shell.

19. The adult sex toy for women of claim 1, wherein at least one vibration motor is provided inside the massaging portion.

20. An adult sex toy for women, comprising:
a main body;
a massaging portion, having a penis-shaped massaging head or an elongated bar-shaped massaging end;
a swing rod, two ends of the swing rod connected to the main body and the massaging portion respectively; and
a fixing member, connected to the main body and configured to be fixed to a human body or an object;
wherein one end of the swing rod is pivotally connected to the main body to allow reciprocal swinging motion, the other end of the swing rod is fixedly connected to the massaging portion, the swinging motion of the swing rod drives the massaging portion to swing relative to the main body.
